(19) United States
(12) Patent Application Publication
(10) Pub. No.: US 2006/0043862 A1
(43) Pub. Date: Mar. 2, 2006

(54) Method of manufacturing field emitter electrode using carbon nanotube nucleation sites and field emitter electrode manufactured thereby

(75) Inventor: Hyoung Dong Kang, Suwon (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Samsung Electro-Mechanics Co., Ltd., Suwon (KR)

(21) Appl. No.: 11/093,649

(22) Filed: Mar. 30, 2005

(30) Foreign Application Priority Data
Sep. 1, 2004 (KR) 10-2004-0069721
Nov. 23, 2004 (KR) 10-2004-0096537

(51) Int. Cl. H01J 1/02; H01J 1/05; H01J 1/14; C25D 5/02

(52) U.S. Cl. 313/311; 313/309; 427/77; 205/118

(57) ABSTRACT

The present invention provides a method of manufacturing a field emitter electrode as well as a field emitter electrode manufactured thereby. The method comprises preparing a plating solution containing carbon nanotubes dispersed therein, immersing a positive electrode and a negative electrode including a substrate which has been surface-treated so as to provide nucleation sites for the carbon nanotubes, in the plating solution, and applying a given voltage between the negative and positive electrodes so as to form a carbon nanotube-metal plating layer on the substrate.

### RELATED APPLICATION

The present application is based on, and claims priorities from, Korean Application Number 2004-69721, filed Sep. 1, 2004, and Korean Application Number 2004-96537, filed Nov. 23, 2004, the disclosure of which is incorporated by reference herein in its entirety.

### BACKGROUND OF THE INVENTION

1. Field of the Invention

The present invention relates to a method of manufacturing a field emitter electrode and a field emitter electrode manufactured thereby. More particularly, the present invention relates to a method of manufacturing a field emitter electrode, which can increase the density and uniformity of carbon nanotube emitters by the use of a negative electrode substrate which has been surface-treated so as to provide nucleation sites for carbon nanotubes on the negative electrode substrate, as well as a field emitter electrode manufactured thereby.

2. Description of the Prior Art

Generally, a field emission display (FED) is a light source based on the emission of electrons in a vacuum, and includes a field emitter electrode in which a plurality of fine tips or emitters that emit electrons are formed. The emitted electrons are accelerated in a vacuum toward a screen of phosphor material so as to excite the fluorescent material which then emits light. Unlike a CRT display, the FED neither requires beam steering circuitry nor produces large amount of unwanted heat. Furthermore, unlike an LCD display, the FED requires no back light, is very light, has a very wide viewing angle, and has a very short response time. Due to such advantages, the FED is now expected to be the next-generation light source for various illumination and display application.

The performance of the field emission display is mainly determined by an emitter electrode capable of emitting electrons. Recently, carbon nanotubes (hereinafter, also referred to as “CNTs”) are used as emitters to improve field emission characteristics.

In the prior art, the emitter electrodes have been fabricated mainly by mixing CNTs with a binder and screen-printing the mixture on a substrate. However, the carbon nanotube emitter electrode manufactured by the screen-printing method has insufficient emission efficiency and its mechanical strength is low. In an attempt to solve such problems, a method of forming carbon nanotube emitters on a substrate by metal-plating was introduced. However, according to the prior metal-plating method, it is difficult to control plating process, and the carbon nanotubes do not uniformly adhere to the substrate.

FIG. 1 shows a conventional system used in plating CNT-metal composites onto the substrate. Meanwhile, FIG. 2 schematically illustrates problems occurring in the prior method of fabricating a carbon nanotube emission electrode by plating CNT-metal composites onto the substrate. In the prior art, by the use of the metal plating system as shown in FIG. 1, a negative electrode 14 and a positive electrode 15 are immersed in a composite plating solution 12 prepared by mixing a plating solution containing metal ions (e.g., Ni ions) with carbon nanotubes (the carbon nanotubes are dispersed in the composite plating solution), and voltage is applied between the two electrodes. For example, if Ni is to be plated on the negative electrode 14, a Ni substrate can be used as the positive electrode 15 and a metal sheet or a flat glass sheet coated with metal can be used as the negative electrode 14 (in some cases, a Ni-coated substrate may be used as a negative electrode, and other metal substrates may be used as a positive electrode). By applying voltage across the two electrodes as described above, the Ni ions and CNTs in the composite plating solution are plated on the surface of the negative electrode 14. As a result, the CNTs are arranged on the negative electrode 14 to form a CNT emission electrode.

However, Ni ions and CNTs 23, which are drawn to the negative electrode 14 during electroplating, move on the substrate by an electric field, as shown by “a” in FIG. 2, and they are first attached and fixed to defects or obstacles 22, as shown by b in FIG. 2. The structure formed as such causes a locally increased electric field at the sites of the defects or obstacles 22, and thus, many more Ni ions and CNTs are drawn to the sites of the defects or obstacles 22. Accordingly, the CNT emission electrode thus formed shows non-uniform emitter distribution and has low emitter density.

Japanese Patent Application No. 2000-98026 by Toshiba Co. discloses a method of attaching carbon nanotubes to a cathode line by plating CNT-metal composites. However, if CNTs are plated onto a cathode line by the method described in said Toshiba patent application, the distribution density and uniformity of CNT emitters is low for the above-mentioned reasons.

However, in order to use the carbon nanotube emitter electrode for field emission displays, carbon nanotube emitters should be attached uniformly on the electrode at high density. If the carbon nanotube emitters are not uniformly distributed on the electrode or are not present in sufficient density, the field emission efficiency of the electrode will be reduced and the life span of displays will be shortened.

### SUMMARY OF THE INVENTION

Accordingly, it is an object of the present invention to provide a method of manufacturing a field emitter electrode, in which carbon nanotube emitters are uniformly distributed on a substrate at high density.

Another object of the present invention is to provide a method of manufacturing a field emitter electrode, which can control the distribution density of carbon nanotube emitters by treating the surface of a substrate so as to provide nucleation sites for carbon nanotubes.

Still another object of the present invention is to provide a field emitter electrode in which carbon nanotubes are uniformly distributed on a substrate in high density.

In one aspect, the present invention provides a method of manufacturing a field emitter electrode, comprising the steps of: preparing a plating solution containing carbon nanotubes dispersed therein; immersing a positive electrode and a negative electrode including a substrate which has been surface-treated so as to provide nucleation sites for the carbon nanotubes, in the plating solution; and applying voltage across the negative electrode and the positive electrode so as to form a carbon nanotube-metal plating layer on the substrate.

In the above aspect, the substrate which has been surface-treated so as to provide the nucleation sites may be a substrate which has been surface-treated so as to form protrusions or depressions on the substrate surface. The protrusions or depressions may have a point or line shape. In another embodiment, the substrate which has been surface-treated so as to provide the nucleation sites may be a substrate which has been surface-treated so as to have a surface with a sawtooth-shaped section. Moreover, the substrate which has been surface-treated so as to provide nucleation sites may also be a substrate which has been surface-treated so as to form irregular protrusions or depressions on the substrate surface.

In another aspect, the present invention provides a field emitter electrode having a carbon nanotube-metal layer uniformly plated on a substrate which has been surface-treated so as to provide nucleation sites for carbon nanotubes.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing a general plating system which is used in the plating of CNT-metal composites;

FIG. 2 illustrates problems occurring in the prior method of plating CNT-metal composites;

FIG. 3 shows substrates which have been surface-treated according to the present invention, in which:

FIG. 3a shows the side cross-section of a substrate having protrusions formed thereon;

FIG. 3b shows the side cross-section of a substrate having depressions formed thereon;

FIG. 3c shows the side cross-section of a substrate having protrusions having a sawtooth-shaped section formed thereon;

FIG. 3d shows a substrate having point-shaped protrusions regularly formed thereon;

FIG. 3e shows a substrate on which line-shaped protrusions have been formed thereon at constant intervals; and

FIG. 3f shows a substrate on which irregular protrusions or depressions have been formed thereon;

FIG. 4a is a photograph showing the field emission density of a field emitter electrode having a CNT-metal plating layer formed on a substrate having irregular protrusions or depressions thereon, according to the inventive method; and

FIG. 4b is a photograph showing the field emission density of a field emitter electrode having a CNT-metal plating layer formed on a substrate by the prior method.

### DETAILED DESCRIPTION OF THE INVENTION

Hereinafter, embodiments of the present invention will be described with reference to the accompanying drawings. Such embodiments may be modified and are not construed to limit the scope of the present invention. Such embodiments are given to provide a more complete description of the present invention to a person ordinarily skilled in the art. Thus, the size of elements in the drawings may be magnified to provide a clear depction.

According to the present invention, when manufacturing a field emitter electrode, a substrate whose surface has been treated so as to provide nucleation sites for CNTs is used as a negative electrode so that CNTs are preferentially plated on desired sites on the substrate. Thus, the distribution uniformity and density of CNTs which adhere to the substrate can be increased and the distribution uniformity, density and orientation of the CNTs can be controlled.

More specifically, protrusions or depressions are formed on the surface of the substrate so as to provide nucleation sites which can be plated with the carbon nanotubes. Thus, locations which are preferentially plated with carbon nanotubes can be uniformly distributed on the substrate, or the locations can be controlled.

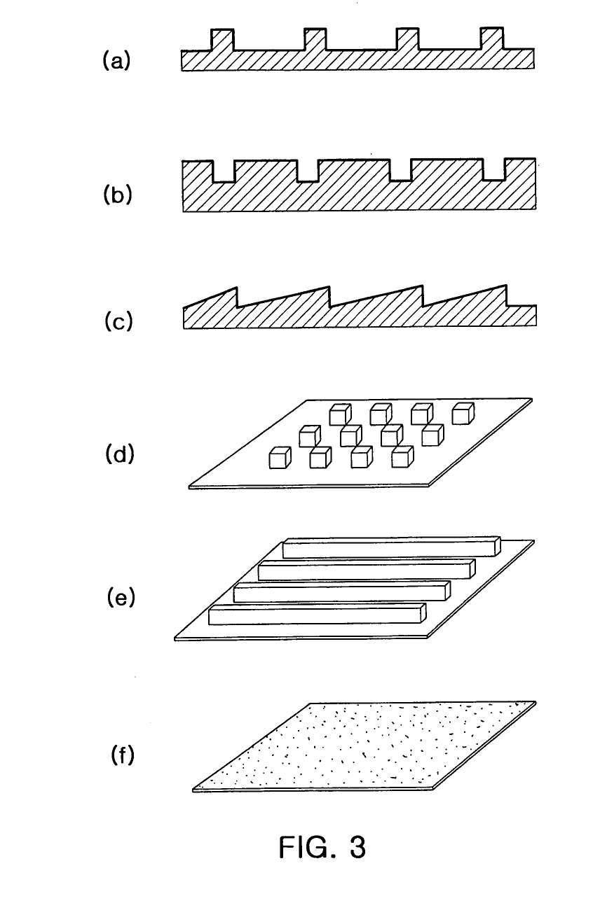

FIGS. 3a to 3f show examples of the surface structure (shape) of a substrate which has been surface-treated so as to provide nucleation sites for carbon nanotubes, in the process of manufacturing a field emitter electrode according to the present invention.

Structures on a substrate (e.g., a copper substrate), which serve as nucleation sites when plating the substrate with the carbon nanotubes, can be protrusions as shown in FIG. 3a, or depressions as shown in FIG. 3b. Meanwhile, the protrusions or depressions can have a sawtooth shaped section as shown in FIG. 3c, a point shape as shown in FIG. 3d, or a line shape as shown in FIG. 3e. For example, the cross section of the point-shaped protrusions in FIG. 3d may be square, rectangular or circular in shape. Also, the surface structures formed on the substrate may be regular or irregular. For example, the surface of a steel sheet can be rubbed with sand paper so as to provide an irregular morphology on the steel sheet surface.

The inventive field emitter electrode may be used for surface light sources. In the inventive field emitter electrode, the intervals between the protrusions or depressions are about 1-20 μm to prevent a point light phenomenon, and the height of the protrusions or the depth of the depressions is preferably lower (<1 μm) than that of CNT tips.

The shape, appearance, interval and the like of the protrusions or depressions, which are formed on the substrate surface so as to provide nucleation sites for carbon nanotubes, can be suitably selected and modified depending on the desired field emission density of field emitters, and are not limited to the shapes shown in FIGS. 3a to 3e.

Methods which can be used to treat the substrate surface so as to provide nucleation sites for carbon nanotubes include lithographic micro patterning, screen printing, and mechanical methods. The mechanical methods are suitable particularly for the formation of depressed patterns.

Furthermore, if regularity in protrusions or depressions is not required, irregular protrusions or depressions as shown in FIG. 3f can be formed on the substrate surface using sandpaper or a sandblasting technique. If the irregular protrusions or depressions are formed, the number of nucleation sites to which carbon nanotubes adhere will be increased, so that the distribution density of carbon nanotubes which are plated onto and adhere to the substrate by the plating of CNT-metal composites will be increased. If the distribution density of the carbon nanotubes on the substrate is increased, the field emission density of the carbon nanotubes when used as field emitters will be increased. The substrate can be made of metal, such as copper or aluminum.

According to the present invention, the plating of CNT-metal composites is performed using the substrate, having been surface-treated so as to provide nucleation sites for carbon nanotubes as described above, as a negative electrode. In other words, the negative electrode, comprising the substrate which has been surface-treated as described above, and a positive electrode, are immersed in the composite plating solution, and electroplating is performed. Thus, a composite plating layer of CNT-metal is formed on the substrate surface.

The composite plating solution may contain carbon nanotubes, metal ions and a cationic dispersing agent. For nickel plating, the metal ions are supplied mainly from NiSO₄ and NiCl₂, and the composite plating solution may additionally contain H₃BO₃. The composition of the composite plating solution having CNTs dispersed therein is generally known in the art, and any person skilled in the art may suitably vary the amount of each component of the composite plating solution.

The carbon nanotubes which can be used in the present invention include, but are not limited to, those prepared by chemical vapor deposition (CVD), and more specifically, multi-wall nanotubes (MWNTs), double wall nanotubes (DWNTs), and single wall nanotubes (SWNTs). It is preferable to use arc-MWNTs which are formed in a straight line.

The amount of CNTs which adhere to the substrate due to plating can be adjusted by controlling plating time, and any person skilled in the art may suitably adjust the amount of CNTs that adhere to the substrate, as the application demands.

Meanwhile, since the carbon nanotubes have a very large surface area and low density, they have strong cohesion. Since the strong cohesion of the carbon nanotubes can interfere with the dispersion of the carbon nanotubes, a dispersing agent is preferably contained in the composite plating solution. In the present invention, a cationic dispersing agent is used as the dispersing agent. Due to the cationic dispersing agent, the carbon nanotubes will bear a positive charge. By the action of the cationic dispersing agent, the carbon nanotubes can be more easily deposited on the negative electrode together with metal ions.

An example of the cationic dispersing agent which can be used in the present invention is, but is not limited to, benzene konium chloride. The cationic dispersing agent is preferably added in an amount of about 50-200% by weight relative to the weight of the carbon nanotubes. If the cationic dispersing agent is used in an amount of less than 50% by weight, it will not sufficiently prevent the aggregation of the carbon nanotube particles, and if it is used in an amount of more than 200% by weight, the dispersing agent will excessively adhere to the electrode so as to interfere with the adhesion of the carbon nanotubes.

The cationic dispersing agent, the carbon nanotubes, metal ion sources and deionized water are mixed with each other and subjected to sonication for about 1 hour. This provides a composite plating solution in which the carbon nanotubes are suitably dispersed.

When electroplating with the composite plating solution is performed using the substrate which has been surface-treated as described above, as a negative electrode, an increased electric field will be present around the structures providing nucleation sites for carbon nanotubes. Thus, the electric field will attract the CNTs in the composite plating solution, so that the CNTs will adhere and be plated concentrically around the structures. Thus, due to the uniform distribution of nucleation sites on the substrate by the surface treatment, the distribution of CNTs adhering to the substrate can be uniform and the density of CNTs can be increased. Also, the density, uniformity and orientation of the CNTs which adhere to the substrate can be controlled by adjusting the shape and position of the structures providing the nucleation sites.

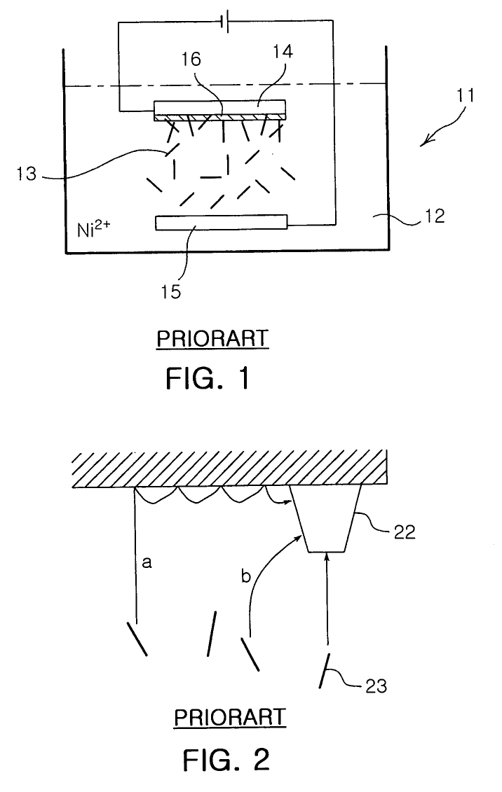

The inventive method of manufacturing the field emitter electrode can perform electroplating by the conventional method as shown in FIG. 1 except that the structures (shapes) are formed on the substrate so as to provide the substrate with the nucleation sites. FIG. 1 shows a state where the negative electrode 14 and the positive electrode 15 have been immersed in the composite plating solution 12 in the plating bath 11. For example, the composite plating solution 12 can be prepared by mixing Ni ions (Ni²⁺), carbon nanotubes (CNTs) and a cationic dispersing agent in deionized water. When a given voltage is applied to the negative electrode 14 and the positive electrode 15, the Ni ions in the composite plating solution will be deposited on the negative electrode 14 together with the carbon nanotubes 13, so as to form a CNT-metal plating layer 16 containing carbon nanotube particles.

According to the present invention, the nucleation sites are uniformly distributed on the substrate, and thus, the CNT-metal plating layer 16 may be more uniformly distributed on the substrate. Accordingly, a field emitter electrode, in which the carbon nanotube emitters are uniformly arranged, can be obtained.

According to the present invention, the surface of the obtained CNT-metal plating layer 16 may be additionally subjected to activation treatment in order to improve the alignment of CNTs. By this activation treatment, the carbon nanotube particles can be sufficiently exposed on the surface of the metal layer, and the alignment of the CNTs is improved. The activation treatment may be performed by, but is not limited to, ion beam, laser beam or tape lift up treatment. Such an activation process can provide a field emitter electrode with better field emission characteristics.

The inventive method allows the manufacturing of a field emitter electrode in which CNTs are uniformly distributed on and adhere well to the substrate. The field emitters manufactured by the inventive method show increased CNT distribution density and uniformity. An increase in the density and uniformity of the field emitters allows the current in each emitter tips to be minimized. Thus, the degradation of emitters caused by resistance heat is prevented, and the life span of the emitters is extended.

Hereinafter, the inventive method of manufacturing the field emitter electrode will be described in further detail by the following specific examples.

### EXAMPLE

### Inventive Example

In Inventive Example, using the plating system as shown in FIG. 1, a CNT-nickel plating layer was formed on a copper substrate whose surface had been treated so as to provide nucleation sites. To prepare a plating solution, 135 g/l of NiSO₄, 22.5 g/l of NiCl₂ and 17.5 g/l of H₃BO₃ were dissolved in deionized water. Then, 10 mg/l of carbon nanotubes and 100 wt % of a dispersing agent (benzene konium chloride (BKC)) were added to the solution and subjected to sonication for about 1 hour, so as to prepare a composite plating solution. Then, the plating solution was put in a plating bath.

Meanwhile, irregular protrusions or depressions were formed on one surface of the copper substrate by sandblasting. The surface-treated copper substrate, as a negative electrode, and a nickel substrate, as a positive electrode, were immersed in the composite plating solution. Thereafter, a voltage of 30V was applied across the two electrodes for about 30 minutes, so that a CNT-Ni composite plating layer having a thickness of about 2 μm was formed on the copper substrate (negative electrode).

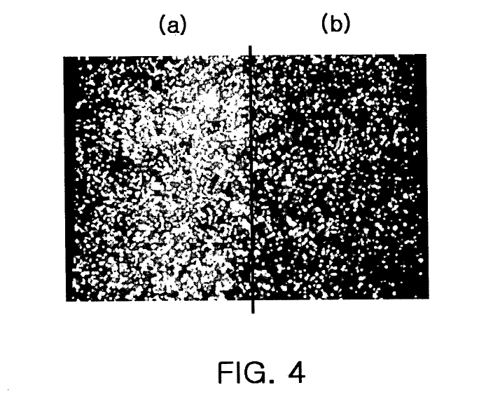

A field emission test was performed using the resulting structure formed by Inventive Example as described above (the copper substrate having the CNT-Ni composite plating layer), as a field emitter electrode. FIG. 4a is a photograph (4 cm×5 cm size) showing field emission points obtained from the field emission test. As shown in FIG. 4(a), the field emission points had a very high density.

### Prior Example

Using the plating system as shown in FIG. 1, a CNT-nickel plating layer was formed on a copper substrate which has not been subjected to surface treatment for providing nucleation sites. For this purpose, 135 g/l of NiSO₄, 22.5 g/l of NiCl₂ and 17.5 g/l of H₃BO₃ were dissolved in deionized water. Then, 10 mg/l of carbon nanotubes and 100 wt % of a dispersing agent (benzene konium chloride (BKC)) were added to the solution and subjected to sonication for about 1 hour, so as to prepare a composite plating solution. Then, the composite plating solution was put in a plating bath.

A copper substrate which had not been subjected to separate surface treatment for forming nucleation sites, as a negative electrode, and a nickel substrate, as a positive electrode, were immersed in the composite plating solution. A voltage of 30V was applied across the two electrodes for about 30 minutes, so that a CNT-Ni composite plating layer having a thickness of about 2 μm was formed on the copper substrate.

A field emission test was performed using the resulting structure formed by Prior Example as described above (the copper substrate having the CNT-Ni composite plating layer), as a field emitter electrode. FIG. 4b is a photograph (4 cm×5 cm size) showing field emission points obtained by the field emission test. As shown in 4(b), the field emission points had a very low distribution density.

As can be seen in FIGS. 4(a) and 4(b), when the carbon nanotubes-Ni metal layer was plated on the substrate which has been surface-treated by sandblasting so as to provide nucleation sites (FIG. 4(a)), the carbon nanotubes adhere to the substrate at high density due to an increase in the number of nucleation sites to which the carbon nanotubes could attach in the plating process. It could be found that the density of the field emission points in Inventive Example was about 3 times higher than that of Prior Example (FIG. 4(b)) using the substrate having no nucleation sites formed thereon.

As described above, the present invention provides the field emitter electrode on which the carbon nanotubes are uniformly distributed at high density. In manufacturing the field emitter electrode according to the present invention, the substrate having specific protrusions or depressions formed thereon is used, so that the protrusions or depression serve as nucleation sites which are plated with the carbon nanotubes. Thus, the carbon nanotubes can be uniformly plated on the substrate at high density and with uniform distribution. Also, positions and densities at which the carbon nanotubes are plated can be controlled. As a result, the field emitter electrode manufactured by the inventive method has increased field emission.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A method of fabricating a field emitter electrode, comprising the steps of:
preparing a plating solution containing carbon nanotubes dispersed therein;
immersing a positive electrode and a negative electrode including a substrate which has been surface-treated so as to provide nucleation sites for the carbon nanotubes, in the plating solution; and
applying a given voltage across the negative and positive electrodes so as to form a carbon nanotube-metal plating layer on the substrate.

2. The method of claim 1, wherein the substrate which has been surface-treated so as to provide the nucleation sites is a substrate which has been surface-treated so as to form protrusions or depressions on the substrate surface.

3. The method of claim 2, wherein the protrusions or depressions have a point or line shape.

4. The method of claim 1, wherein the substrate which has been surface-treated so as to provide the nucleation sites is a substrate which has been surface-treated so as to have a surface with a sawtooth-shaped section.

5. The method of claim 1, wherein the substrate which has been surface-treated so as to provide the nucleation sites is a substrate which has been surface-treated so as to form irregular protrusions or depressions on the substrate surface.

6. The method of claim 1, which further comprises subjecting the carbon nanotube-metal plating layer to activation treatment so as to improve the alignment of the carbon nanotubes, after forming the carbon nanotube-metal plating layer.

7. The method of claim 1, wherein the plating solution contains metal ions and a cationic dispersing agent.

8. The method of claim 7, wherein the metal ions are nickel ions, and the substrate is a copper substrate.

9. A field emitter electrode manufactured by claim 1, which has a carbon nanotube-metal plated layer on a substrate which has been surface-treated so as to provide nucleation sites.

10. A field emitter electrode manufactured by claim 2, which has a carbon nanotube-metal plated layer on a substrate which has been surface-treated so as to provide nucleation sites.

11. A field emitter electrode manufactured by claim 3, which has a carbon nanotube-metal plated layer on a substrate which has been surface-treated so as to provide nucleation sites.

12. A field emitter electrode manufactured by claim 4, which has a carbon nanotube-metal plated layer on a substrate which has been surface-treated so as to provide nucleation sites.

13. A field emitter electrode manufactured by claim 5, which has a carbon nanotube-metal plated layer on a substrate which has been surface-treated so as to provide nucleation sites.

14. A field emitter electrode manufactured by claim 6, which has a carbon nanotube-metal plated layer on a substrate which has been surface-treated so as to provide nucleation sites.

15. A field emitter electrode manufactured by claim 7, which has a carbon nanotube-metal plated layer on a substrate which has been surface-treated so as to provide nucleation sites.

16. A field emitter electrode manufactured by claim 8, which has a carbon nanotube-metal plated layer on a substrate which has been surface-treated so as to provide nucleation sites.
